(19) United States
(12) Patent Application Publication
(10) Pub. No.: US 2006/0277887 A1
(43) Pub. Date: Dec. 14, 2006

(54) Method for processing organic plant matter into dry powder, oil and juice products

(75) Inventor: Robert E. Dalton, Lewisville, NC (US)

Correspondence Address: CHRISTOPHER C. DREMANN, P.C., 18 MALLARD COURT, GRANITE FALLS, NC, 28630, US

(73) Assignee: NUTRAGON, LLC

(21) Appl. No.: 11/442,794

(22) Filed: May 30, 2006

Related U.S. Application Data
(60) Provisional application No. 60/685,844, filed on May 31, 2005.

(51) Int. Cl. A01D 46/00

(52) U.S. Cl. 56/330

(57) ABSTRACT

Methods are disclosed for processing organic plant matter into dry powder, oil and juice products for use alone or in combination with other constituents as a food additive, nutriment, dietary supplement, nutraceutical, pharmaceutical or a component of a cosmetic product having a high concentration of polyphenolic compounds, including the naturally occurring antioxidant resveratrol. In a particular embodiment, Muscadine grapes and rice hulls are mixed together in a predetermined ratio and subsequently pressed to extract the bulk of the grape juice from the Muscadine grapes, resulting in a residue consisting essentially of Muscadine grape marc and rice hulls. An active enzyme may be introduced into the mixture to soften the grape skins and thereby facilitate break down of the mixture into the residue. The residue is then pressed again, dried at low heat and high air flow, and the grape seeds separated from the remaining residue. The remaining residue is then ground, fragmented or powdered to produce the dry powder product. The separated grape seeds may be further processed to extract grape seed oil and produce a sludge consisting primarily of crushed grape seeds, which can be further processed by powdering to form a grape seed powder having a high concentration of polyphenolic compounds, including resveratrol. The residue is stored at a temperature only slightly above 32° F. (0° C.) and less than about 60° F. (15° C.) to both preserve and promote the continued metabolic synthesis of polyphenolic compounds, including resveratrol.

### CROSS REFERENCE To RELATED APPLICATION

This application claims the benefit of U.S. Provisional Application No. 60/685,844, filed on May 31, 2005, the disclosure of which is incorporated herein in its entirety.

### FIELD OF THE INVENTION

This invention relates to an improved method for processing organic plant matter into dry powder, oil and juice products, and to the dry powder, oil and juice products processed in accordance with the method. More specifically, the invention is a method for processing grapes and grape by-products into dry powder, oil and juice products having a high concentration of polyphenolic compounds, including resveratrol, for use alone or in combination with other constituents as a food additive, nutriment, dietary supplement, nutraceutical, pharmaceutical or a component of a cosmetic product.

### BACKGROUND OF THE INVENTION

It is well known that organic plant matter contains numerous biologically active (also referred to herein as “bioactive”) components, such as vitamins, minerals, nutrients and natural antioxidants, and that these bioactive components provide significant nutritional, health and therapeutic benefits. For example, many natural substances of plant matter origin contain polyphenolic compounds that exert anti-tumor and antioxidant activity, block the formation of free radicals, neutralize existing free radicals, reduce oxidative enzymes and decrease the concentration of lipoperoxides in plasma. These effects are principally attributed to the polyphenolic compounds, including resveratrol, naturally occurring in certain vegetables, fruits and nuts (e.g., peanuts), and especially in grapes and grape by-products (e.g., grape vines, stems, leaves, roots, seeds, etc.). Resveratrol is a natural phytoalexin known to inhibit tissue factor expression in vascular cells, and therefore, is believed to be beneficial in preventing heart disease and certain cancers, as well as blood disorders, inflammatory conditions such as arthritis, and other maladies. Grapes and grape by-products contain several bioactive polyphenolic compounds, including flavonoids (e.g., catechins and oligomers thereof; flavonols and anthocyanidols; proanthocyanidins; quercitins; etc.) and non-flavonoids (e.g., stilbene derivatives, such as resveratrol). It is the non-flavonoid resveratrol, however, that is regarded as being most responsible for the beneficial effects on the human cardiovascular system attributed to grape-derived products, such as wine, grape juice, grape powder, grape seed powder and grape seed oil. Although the underlying mechanisms are not entirely understood, the chemo-protective actions of resveratrol are believed to be related at least in part to its free radical negating and anti-inflammatory effect.

Numerous methods exist for extracting the beneficial bioactive components from organic plant matter. Typically, the organic plant matter is first crushed, squeezed or pressed to extract the juice. The natural pectin in the juice is then removed and the juice subjected to a high heat drying process to remove most of the liquid. Ideally, the high heat drying process results in a dry powder product that can be incorporated into various food additives, nutriments, dietary supplements, nutraceuticals, pharmaceuticals, and health and beauty products, such as cosmetics. Such pressing and high heat drying processes are utilized for extracting polyphenolic compounds from grapes and grape by-products. These processing methods, however, generally suffer from inherent limitations that are particularly prevalent when utilized to process grapes and grape by-products. First and foremost, the juice contains only a fraction of the beneficial polyphenolic compounds available from the grapes and grape by-products. As a result, vast quantities of the juice must be processed in order to obtain any appreciable amount of the polyphenolic compounds. Furthermore, the solid residue that remains after extracting the juice, generally referred to as the “pomace,” and more specifically referred to as the “marc” with reference to fermented grapes used in wine production, is typically discarded and not utilized for any commercial purpose. Recently though, it has become widely recognized that the highest concentration of the beneficial bioactive components, and in particular polyphenolic compounds including antioxidants such as resveratrol, reside in the husks, skins and seeds of the grapes. It is these components that constitute the bulk of the pomace, as well as the marc, that is discarded in the known extraction methods.

Another problem encountered with the known extraction methods for organic plant matter, including grapes and grape by-products, is that high heat processing significantly degrades the efficacy of most bioactive components. In particular, high heat drying in a conventional drying and/or fragmenting apparatus causes the natural sugars present in the organic plant matter to caramelize and coagulate into a viscous mass. Consequently, vegetables and fruits containing high concentrations of natural sugars can clog the drying apparatus when subjected to elevated temperatures requiring the drying apparatus to be cleaned repetitively and resulting in inefficient and uneconomical processing of the dry powder product. U.S. Pat. No. 6,190,716 to Galbreath, Jr. discloses a method for preparing a natural product, such as a food supplement containing resveratrol derived from Muscadine grapes. The grapes are first crushed and de-juiced. The pulp of the crushed and de-juiced Muscadine grapes is then broken down by heating the pomace and with optional enzymatic action. The broken down pulp is then extracted from the pomace and the skins and seeds of the extracted pulp are collected into net bags. The net bags are then placed into a conventional rotary drum dryer at an elevated temperature of about one hundred eighty degrees Fahrenheit (180° F.) and the contents dried to less than about one percent (1%) moisture. The dried material is next gathered into plastic freezer bags and stored in food grade containers at slightly less than room temperature (between about 60° F. and 70° F.). After a predetermined time, the dried material is ground into a fine, dry powder that may be encapsulated into gelatin capsules or combined with other food products.

U.S. Pat. No. 4,950,491 to Varga discloses an alternative process for preparing dry powdered fruit from whole fruit or from the by-products of fruit processing, and in particular, the husk residue (i.e., pomace) of fruit processing. The fruit or fruit by-products are cleaned, cut-up and then dried in a microwave oven at a maximum temperature of about sixty-five degrees Celsius (65° C.). If necessary, the microwave dried fruit or fruit by-products may be further dried using an infrared radiator, such as a lamp, to gently reduce the moisture content at the surface of the fruit matter. Regardless, the dried fruit matter is then ground in a suitable grinding apparatus to a particle size ranging between fine powder and coarse grist. If desired, the ground fruit matter can be fractionated, for example in a cyclone, to obtain different fractions of matter ranging in size between mealy-fine and granular crumbly. The gentle microwave drying process increases the efficacy of the bioactive components. However, a substantial amount of time and energy is required to process the fruit matter. Accordingly, the process is not efficient for the production of large quantities of a dry powder product or oil.

U.S. Pat. No. 6,479,081 to Feries discloses a method for obtaining grape pomace and grape seed tannin comprising a first step of extracting a crude tannin fraction by solid-liquid extraction from a mixture of grape marc and/or seed in an aqueous solvent of sulphited water (H₂O+SO₂). In a second step, the aqueous solvent is then removed from the extract to produce a concentrate of the crude tannin fraction. In a third step, the crude tannin fraction is then purified by liquid-liquid extraction through evaporation of the solvent to solubilize the tannin, selective adsorption of the polyphenolic compounds of the tannin on resin, and subsequent filtration on activated charcoal. Advantageously, the crude tannin fraction is extracted in the first step at a temperature of at most 25° C., and preferably between about 15° C. and 25° C. Preferably, the aqueous solvent is removed in the second step by evaporation under vacuum at a temperature of at most 75° C. The resulting concentrate is immediately cooled to a temperature of at most 30° C. Preferably, the crude tannin fraction adsorbed on resin in the third step is filtered by selective diafiltration at a temperature of at most 25° C.

Even if the elevated temperature of the drying process does not caramelize the natural sugars of the organic plant matter, and regardless whether the extraction method includes process steps that subject the organic plant matter to excessive temperature, the plant material nevertheless may clump together within a conventional drying apparatus. In particular, the organic plant matter may cling to the inner surface of the wall of the drying apparatus, thereby subjecting the material to friction-induced heating and prolonged exposure to elevated temperature. Furthermore, the organic plant matter residue clinging to the inner surface of the wall of the drying apparatus is not available to be fragmented into a dry powder product. The prolonged exposure to heat can significantly reduce the efficacy of the bioactive components for the reasons previously discussed, while the reduced fragmentation of the organic plant matter limits the efficiency of the extraction method. Accordingly, a conventional drying apparatus that simultaneously removes moisture and fragments the organic plant matter, such as a cyclonic dryer, further limits the efficiency of processing a dry powder product and its constituent polyphenolic compounds, including resveratrol.

### SUMMARY OF THE INVENTION

In one aspect, the invention is embodied by a method for processing organic plant matter into a food additive, nutriment, dietary supplement, nutraceutical, pharmaceutical or a component of a cosmetic product having a high concentration of a polyphenolic compound. An exemplary embodiment of the method includes pressing the organic plant matter to remove at least about 50% of the moisture content from the organic plant matter. The method further includes storing the pressed organic plant matter at a temperature greater than about 32° F. (0° C.) and less than about 60° F. (15° C.). Preferably, the organic plant matter is stored at the reduced temperature for at least about 14 days, and more preferably, for at least about 30 days. The method includes the further steps of drying the stored organic plant matter and grinding the dried organic plant matter into a dry powder product. The method may include the optional step of adding at least one active enzyme to the organic plant matter. Preferably, the active enzyme is selected from the group consisting of pectinase and amylase types. In the event that the organic plant matter comprises seeds, the method may include separating the seeds from the dried organic plant matter before grinding. In addition, the method may optionally further include re-pressing the stored organic plant matter to remove greater than about 80% of the moisture content from the stored organic plant matter. Preferably, the organic plant matter is dried using high air flow convection without the addition of heat in excess of about 120° F. (50° C.) and the steps of pressing and grinding are each performed at a temperature less than about 77° F. (25° C.).

In another aspect, the invention is embodied by a method for processing grapes and grape by-products including mixing rice hulls with the grapes and grape by-products and pressing the mixture. The method further includes storing the pressed mixture at a temperature greater than about 32° F. (0° C.) and less than about 60° F. (15° C.). The method further includes drying the stored mixture and grinding the dried mixture. The method may optionally further include adding at least one active enzyme to the mixture wherein the at least one enzyme is selected from the group consisting of pectinase and amylase types. In the event that the mixture comprises grape seeds, the method may further include separating the grape seeds from the dried mixture before grinding. In addition, the method optionally may further include re-pressing the stored mixture to remove greater than about 80% of the moisture content from the stored mixture. Preferably, the mixture is stored for at least about 14 days, and more preferably, for at least about 30 days. Also, the mixture is preferably dried using high air flow convection without the addition of heat in excess of about 120° F. (50° C.).

In yet another aspect, the invention is embodied by a dry powder for use as a food additive, nutriment, dietary supplement, nutraceutical, pharmaceutical or cosmetic product having a high concentration of a polyphenolic compound. The dry powder includes grapes and rice hulls. The grapes and rice hulls are mixed together, then pressed and dried to remove moisture from the mixture, and then ground into the dry powder. The ratio of grapes to rice hulls by weight is at least about 10:1. Preferably, the ratio of grapes to rice hulls by weight is between about 10:1 and about 50:1, and more preferably, between about 20:1 and about 30:1. The dry powder may further include at least one active enzyme selected from the group consisting of pectinase and amylase types. In an exemplary embodiment, at least the grapes are stored for at least about 14 days at a temperature greater than about 32° F. (0° C.) and less than about 60° F. (15° C.) before the mixture of grapes and rice hulls is dried and ground. As a result, the concentration of the polyphenolic compound in the dry powder is greater than at least three times the concentration of the polyphenolic compound when the grapes are not stored for at least 14 days at a temperature greater than about 32° F. (0° C.) and less than about 60° F. (15° C.) before the mixture of grapes and rice hulls is dried and ground.

In yet another aspect, the invention is embodied by a method of processing a Muscadine grape-derived dry powder, oil or juice product having a high concentration of a polyphenolic compound. The method includes mixing Muscadine grapes and rice hulls in a predetermined proportion wherein the ratio of Muscadine grapes to rice hulls is at least about 10:1. The method further includes pressing the mixture to extract the bulk of the grape juice present in the Muscadine grapes, thereby forming a residue comprising at least Muscadine grape marc and rice hulls. The method further includes storing the residue for at least about 14 days at a temperature greater than about 32° F. (0° C.) and less than about 60° F. (15° C.) in order to stimulate and promote the continued metabolic synthesis of the polyphenolic compound in the residue. The method further includes drying the residue using a heat source accompanied by warm air convection at a temperature not exceeding about 120° F. (50° C.) and grinding the residue into the Muscadine grape-derived dry powder, oil or juice product. The method may optionally further include adding at least one active enzyme to the mixture of Muscadine grapes and rice hulls. Preferably, the at least one active enzyme is a pectinase or amylase type. The method may optionally further include re-pressing the residue after storing the residue to remove greater than about 80% of the moisture remaining in the residue. The method may optionally further include separating any grape seeds from the mixture and then pressing the grape seeds to extract grape seed oil and/or sludge.

In yet another aspect, the invention is embodied by a Muscadine grape-derived dry powder, oil or juice product having a high concentration of resveratrol. The product includes a mixture of at least Muscadine grapes and rice hulls wherein the ratio of Muscadine grapes to rice hulls is at least about 10:1. Furthermore, the Muscadine grape-derived product has a concentration of resveratrol by weight that ranges between about 0.01 milligrams (0.01 mg) and about 100 milligrams (100 mg) per 100 grams (100 g) of the dry powder product. The Muscadine grape-derived dry powder, oil or juice product may further include at least one active enzyme selected from the group consisting of pectinase and amylase types. In an exemplary embodiment, the mixture of at least Muscadine grapes and rice hulls is stored for at least about 14 days at a temperature of greater than about 32° F. (0° C.) and less than about 60° F. (15° C.) in order to stimulate and promote the continued metabolic synthesis of the resveratrol in the mixture.

### BRIEF DESCRIPTION OF THE DRAWINGS

These and other features, aspects and advantages of the present invention are better understood when the following detailed description of the invention is read with reference to the accompanying drawings, in which like reference numerals indicate like parts. The drawing figures illustrate various exemplary embodiments of the invention described in greater detail below. Therefore, the drawing figures should not be construed to limit the scope of the invention in any manner to the particular examples shown and described herein.

FIG. 1 is a schematic diagram illustrating an exemplary apparatus for processing organic plant matter, and in particular grapes and grape by-products, into dry powder, oil and juice products according to the present invention.

FIG. 2 is a flowchart illustrating the steps of an exemplary method for processing Muscadine grapes and rice hulls into dry powder, oil and juice products using the apparatus of FIG. 1.

FIG. 3 is a table listing the ranges of concentrations by weight of various polyphenolic compounds per 100 grams (100 g) of a dry powder product processed from a mixture of Muscadine grapes and rice hulls using the apparatus of FIG. 1 in accordance with the method of FIG. 2.

### DETAILED DESCRIPTION OF THE INVENTION

The present invention provides an improved method for processing organic plant matter into dry powder, oil and juice products comprising a high concentration of bioactive components, and in particular polyphenolic compounds, including resveratrol. Broadly, the method includes pressing and/or drying the organic plant matter to remove the bulk of the moisture and then grinding the pressed/dried organic plant matter to produce a dry powder, oil or juice that can be utilized alone or in combination with other constituents as a food additive, nutriment, dietary supplement, nutraceutical, pharmaceutical or a component of a cosmetic product that provides a nutritional, health and/or therapeutic benefit. After pressing, the de-juiced organic plant matter is stored at a temperature only slightly above 32° F. (0° C.) in order to promote the continued metabolic synthesis of the beneficial bioactive components, thereby further increasing the resulting concentration of the polyphenolic compounds that provide the nutritional, health and/or therapeutic benefits. As indicated in the following table, the concentration of resveratrol measured in mg/g of the resulting dry powder, oil or juice product experienced an average over 9-fold increase when stored at slightly above freezing temperature for

| | Resveratrol | Cold Prep | |
|---|---|---|---|
| Trial # | mg/g | (35.5 F.) | Storage > 3 mos. |
| 1 | 0.737 | − | − |
| 2 | 0.720 | − | − |
| 3 | 0.667 | − | − |
| 4 | 3.762 | + | + |
| 5 | 12.07 | + | + |
| 6 | 3.908 | + | + |
| 7 | 3.146 | + | − |
| 8 | 2.437 | + | − |

greater than 3 months (i.e., trials 4, 5 and 6), and experienced an average almost 4-fold increase when stored at slightly above freezing temperature for more than 14 days, but less than 3 months (i.e., trials 7 and 8).

Preferably, both the pressing and grinding steps are likewise performed at a processing temperature that is sufficiently below ambient room temperature, for example less than about 77° F. (25° C.) and preferably between about 32° F. (0° C.) and about 60° F. (15° C.), to preserve the efficacy of the polyphenolic compounds, including resveratrol. An active enzyme may be added to the organic plant matter to facilitate breaking down the plant matter prior to pressing or to direct the metabolic activity of the plant matter during cold storage to enhance the production of polyphenolic compounds, including resveratrol. By directing metabolism, the active enzyme makes the polyphenolic compounds more bio-available. In certain instances, the organic plant matter is first pressed and then separated into two or more subcomponents (e.g., juice, pomace and seeds) that produce both a synergistic effect when processed together, as well as a nutritional, health and/or therapeutic benefit when processed on their own. The separated components may then be individually dried and ground into a dry powder product, or may be further processed in any conventional manner, such as subsequent pressing to extract an oil product. Regardless, the resulting dry powder, oil and juice products are useful alone or in combination with other constituents that can be incorporated into various food additives, nutriments, dietary supplements, nutraceuticals, pharmaceuticals and cosmetic products, such as health or beauty aids, having a high concentration of bioactive components, and in particular natural antioxidants, such as the polyphenolic compounds, including resveratrol, that provide a significant nutritional, health and/or therapeutic benefit.

In a preferred embodiment, the organic plant matter comprises grapes and grape by-products. As used herein, the term “grape by-products” refers to components of the grape plant other than the grapes themselves, which are conventionally used to produce commercial grape-derived beverages, such as wines and grape juices, and vinegars. In particular, the grape by-products may include grape vines, stems, leaves, roots and seeds. If necessary, the grapes and grape by-products are first mixed together and the resulting mass is then pressed to remove the bulk of the liquid grape juice. Preferably, at least about fifty percent (50%) and more preferably at least about seventy percent (70%) of the moisture is removed from the mixture of grapes and grape by-products. An active enzyme or combination of enzymes may be added to the mixture of grapes and grape by-products before or after pressing. Preferably, the active enzyme is added prior to pressing the mixture for the purpose of softening the skins of the grapes and thereby facilitating the break down of the grapes and grape by-products. However, enzymatic action may also direct the metabolic activity of the pressed mixture (i.e., pomace) during cold storage to enhance the production of polyphenolic compounds, including resveratrol. Any suitable enzyme may be employed for either or a different purpose. For example, active enzymes of the pectinase and amylase types may be utilized to cleave different parts of the grapes, and in particular the skins, so as to render the grapes softer and easier to mechanically break apart during pressing and subsequent processing steps. Regardless, the pressed mixture (i.e., the de-juiced pomace and grape by-products) is then stored at a temperature only slightly above 32° F. (0° C.) for an extended period of time in order to promote continued metabolic synthesis and thereby increase the concentration of the polyphenolic compounds, including resveratrol in the resulting dry powder, oil and juice products. At the same time, “cold storage” of the pressed mixture also safeguards the accumulated antioxidant polyphenolic compounds against thermal or oxidative degradation. Preferably, only fresh grapes and grape by-products are pressed. In the event it is necessary to store the grapes and grape by-products for an extended period of time prior to pressing, they may likewise be stored, for example in a freezer, at a temperature significantly below ambient temperature. The pressed mixture remains in the cold storage for at least about 14 days, and more preferably at least about 3 months. During that time, an additional amount of moisture naturally evaporates from the mixture so that about as much as eighty percent (80%) of the moisture of the original mixture is removed. Following cold storage, the pressed mixture is pressed a second time to further reduce the amount of moisture remaining in the mixture. The second pressing produces a juice residue comprising a high concentration of polyphenolic compounds, including resveratrol, which may be used in the production of grape-derived liquids, such as vinegars. Following the second pressing, the mixture is dried to remove essentially all of the remaining moisture. At the same time, the grape seeds may be separated from the mixture for a purpose to be described below. The mixture may be dried and the grape seeds separated by any suitable means that does not subject the mixture to elevated temperatures that can reduce the concentration or degrade the efficacy of the polyphenolic compounds present in the mixture. For example, the mixture may be dried using high air flow convection without the addition of significant (greater than about 120° F. (50° C.)) heat from an external heat source. The grape seeds may be separated from the mixture during or after drying using a separator that likewise does not introduce significant (greater than about 120° F. (50° C.)) heat from an external heat source. The separated grape seeds may then be processed in a conventional manner to produce a dry powder product, such as a relatively pure grape seed powder. Alternatively or in addition, the grape seeds may be pressed again under high force to produce a grape seed sludge or oil having a high concentration of a unique profile of polyphenolic compounds, including resveratrol. Regardless, the re-pressed and dried mixture is then ground in any conventional manner to produce a dry, grape-derived powder product for use alone or in combination with other constituents as a food additive, nutriment, dietary supplement, nutraceutical, pharmaceutical or cosmetic product, such as an over-the-counter health or beauty aid, having a high concentration of a unique profile of polyphenolic compounds, including resveratrol. Both of the pressing steps, the drying step and the grinding step are performed at a temperature that is at or below ambient temperature, for example less than about 77° F. (25° C.), and preferably between about 32° F. (0° C.) and 60° F. (15° C.), in order to promote the further production of, as well as to preserve the efficacy of, the polyphenolic compounds, including resveratrol.

In another preferred embodiment, the organic plant matter consists of a mixture of grapes and rice hulls. While any known variety of grapes can potentially produce a dry powder product comprising a beneficial bioactive component, the Muscadine variety of grape is preferred due to its inherently higher concentration of polyphenolic compounds, including resveratrol. Accordingly, the organic plant matter in this embodiment of the invention consists of a mixture of Muscadine grapes and rice hulls. An enzyme may optionally be added to the mixture for the purposes previously described. Rice hulls are preferred over other varieties of press filler components because rice hulls contain beneficial nutrients and fiber. Furthermore, they are rich in B vitamins and contain an active form of vitamin E, which acts synergistically with the polyphenolic compounds in the grapes and grape by-products, and serves to further protect the polyphenolic compounds from oxidative degradation. The ratio of Muscadine grapes to rice hulls by weight is at least about 10:1 and does not exceed about 50:1. More preferably, the ratio of Muscadine grapes to rice hulls is between about 20:1 by weight and about 30:1 by weight. In a particular example provided herein, about 100 pounds of rice hulls are mixed with about 1 ton (2200 pounds) of Muscadine grapes. The juice of the Muscadine grapes is extracted from the mixture in any suitable manner, such as by a conventional bladder press or screw press, to produce Muscadine grape juice having a high concentration of polyphenolic compounds, including resveratrol. The grape juice may be used as a constituent of a food product, such as a juice or juice by-product, or may be fermented in a suitable manner to produce wines.

The residue after removing the bulk of the moisture from the mixture consists of Muscadine grape pomace or marc, Muscadine grape seeds and rice hulls. The residue is placed in cold storage for a suitable period of time as described above and thereafter re-pressed to extract essentially all of the remaining moisture, which consists primarily of Muscadine grape juice having an exceptionally high concentration of polyphenolic compounds, including resveratrol. Preferably, the Muscadine grape juice is collected and processed into a juice product for use alone or in combination with other constituents as a food additive, nutriment, dietary supplement, nutraceutical, pharmaceutical or a component of a cosmetic product. The residue is then dried and the grape seeds optionally separated from the pressed Muscadine grape pomace or marc and rice hulls in the manner previously described. Alternatively, the grape seeds may be separated from the grape pomace or marc and rice hulls utilizing a conventional macerator and separation process. However, if the grape seeds are separated from the Muscadine grape pomace or marc and rice hulls it is important that the grape seeds are separated from the residue without the addition of water or any liquid solvent that might dilute the residue and possibly wash out a portion of the beneficial polyphenolic compounds, including resveratrol. The grape seeds may be processed by further pressing, drying or grinding, preferably at high pressure and low temperature, to produce a dry powder, sludge or oil product, such as a relatively pure Muscadine grape seed powder or grape seed oil having an enhanced concentration and unique profile of polyphenolic compounds, including resveratrol. The residual grape seed cake is essentially fat-free and likewise may be ground into a fat-free grape seed powder having an enhanced concentration and unique profile of polyphenolic compounds, including resveratrol.

Although optional, processing the grape and grape by-products with the addition of an active enzyme softens the skins of the grapes, thereby facilitating the pressing, re-pressing, separating and grinding processes, as well as promoting and preserving the production of polyphenolic compounds, thus ultimately resulting in a higher concentration of free resveratrol available for absorption from the grape-derived dry powder, oil and juice products. It is believed that in addition to the nutritional benefits previously mentioned, the rice hulls serve to prevent the mixture from congealing during and after pressing, for example by squeezing the mixture in a conventional bladder press or screw press. Most importantly in this embodiment of the invention, the mixture of Muscadine grapes and rice hulls (along with the optional active enzyme) is stored for an extended period of time at a temperature that is sufficiently below room temperature, and preferably is only slightly above freezing, in order both to promote the continued production of polyphenolic compounds and to preserve the already existing or metabolized polyphenolic compounds. In particular, storing the grape pomace or marc and rice hulls after pressing has been proven to stimulate the continued production of polyphenolic compounds, including resveratrol. Meanwhile, processing the mixture of Muscadine grapes and rice hulls at a temperature that does not exceed about 60° F. (15° C.) preserves the polyphenolic compounds, including resveratrol already present in the mixture or produced during cold storage. It is believed that the reduced temperature effects a higher concentration of the polyphenols by stressing the constituents and thereby steering the remaining metabolic synthesis “machinery” of the grape pomace or marc and rice hulls along the path of producing more polyphenolic compounds, including resveratrol.

Preferably, the pressed residue is stored at a temperature only slightly above 32° F. (0° C.) in order to promote continued metabolic synthesis, thereby increasing the resulting concentration of the polyphenolic compounds in the resulting dry powder, oil and juice products, as well as the grape seeds separated from the residue and the corresponding products. The mixture and pressed residue is processed at a temperature between about 32° F. (0° C.) and 60° F. (15° C.) in order to preserve the efficacy of the polyphenolic compounds, including resveratrol, by not subjecting the polyphenolic compounds to damaging elevated temperature. The pressed residue is stored at the reduced temperature for an extended period of time, preferably between at least about 14 days and 6 months (180 days), to optimize the efficacy of the nutritional, health and/or therapeutic benefit provided by the polyphenolic compounds, including resveratrol. Typically, the pressed residue is stored at the reduced temperature for between 1 month (30 days) and about 3 months (90 days). During the extended period of time, a portion of the remaining moisture content of the pressed residue is removed due to normal evaporation. Thereafter, the pressed residue is preferably pressed again as previously described and then further dried using a suitable low heat/high air flow process.

In this preferred embodiment of the invention, the pressed residue is preferably dried using a conventional heat source accompanied by air convection at a temperature not exceeding about 120° F. (50° C.). Finally, the cold-processed, dried residue is separated into essentially three components consisting of: 1) grape pomace or marc comprising predominantly grape hulls (husks); 2) a lesser consistency mixture comprising a combination of about sixty percent (60%) grape hulls and about forty percent (40%) rice hulls by weight; and 3) grape seeds. The grape hulls are ground in any conventional manner to produce a dry powder product derived principally from Muscadine grapes for use alone or in combination with other constituents as a food additive, nutriment, dietary supplement, nutraceutical, pharmaceutical or cosmetic product, such as an over-the-counter health or beauty aid, having a high concentration of polyphenolic compounds, including resveratrol. The separated grape seeds are further pressed, for example by a cold press, to extract relatively pure grape seed oil and a high residue oil sludge forming a dry grape seed meal cake which is essentially devoid of oil. The grape seed meal cake processed in this manner is high in fiber, low in fat (oil free), low in carbohydrate and contains a relatively high concentration of naturally occurring antioxidants, such as resveratrol. Similarly, the oil processed in this manner has an exceptionally high concentration of polyphenolic compounds, including resveratrol. The oil has had minimal exposure to heat, and therefore, has experienced minimal degradation or oxidation. In addition, the extended period of time in cold storage has enabled more beneficial polyphenolic compounds to be produced in the grape seeds and the resulting grape seed oil. Alternatively, the grape seeds may be dried and ground in the same manner as the pressed residue into a dry grape seed powder that is high in fiber, low in fat (i.e., oil free), low in carbohydrate and contains a relatively high concentration of naturally occurring antioxidants, including resveratrol. In yet another embodiment, the grape seeds may be further dried, for example by passing air around the seeds at high velocity and at a mildly elevated temperature, and then ground or fragmented in any suitable manner to produce a dry grape seed powder that is high in fiber, low in carbohydrate and contains a relatively high concentration of naturally occurring antioxidants, including resveratrol.

Any of the Muscadine grape-derived dry powder, oil and juice products described above is suitable for use as a food additive, nutriment, dietary supplement, nutraceutical, pharmaceutical or constituent of a cosmetic product. For example, the moisture collected by the second pressing of the grape pomace or marc and rice hulls following cold storage may be used as a food additive in the production of another beverage or food product, such as juice, wine or vinegar. The grape seed oil from the subsequent pressing of the grape seeds following separation may be used as a constituent in the production of a cosmetic product or a health and beauty aid. If desired, the high residue oil sludge meal cake produced in conjunction with the grape seed oil during subsequent pressing of the grape seeds may be used as a constituent in the production of a nutriment, dietary supplement or animal food product intended for consumption by a domesticated animal (e.g., bird, cow, pig, chicken, horse, primate, reptile, fish, cat or dog).

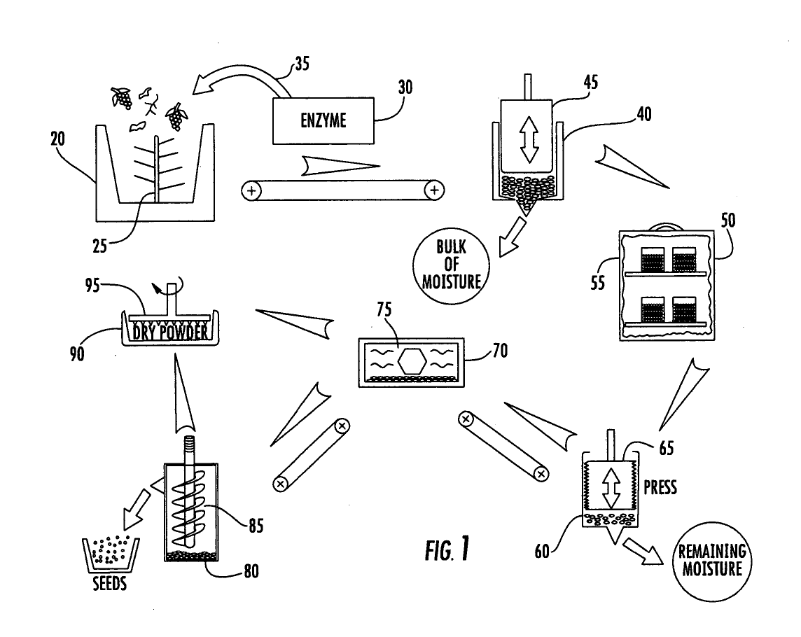

Referring now to the accompanying drawings, FIG. 1 shows an exemplary apparatus, indicated generally at 10, for processing organic plant matter into a dry powder, oil or juice product according to the present invention. The apparatus 10 comprises a mixing station 20, an optional enzyme introducing station 30, a first pressing (i.e., de-juicing) station 40, a cold storage station 50, a second pressing station 60, a drying station 70, an optional seed separating station 80, and a grinding/fragmenting station 90. One or more of the mixing station 20, the enzyme introducing station 30, the cold storage station 50, the second pressing station 60, the drying station 70 and the seed separating station 80 may be utilized in different combinations and in the same or different order in various embodiments of the processing methods intended to be encompassed by the present invention. For example, in the broadest embodiment of the methods it is envisioned that organic plant matter consisting essentially of Muscadine grapes and rice hulls will be mixed together at the mixing station 20, pressed at the first pressing station 40 to extract the bulk of the moisture (i.e., grape juice) from the mixture, and the resulting grape pomace or marc and rice hulls subsequently ground at the grinding/fragmenting station 90 to produce a Muscadine grape-derived dry powder product having a high concentration of polyphenolic compounds, including resveratrol.

In another contemplated embodiment of a method according to the invention grapes and grape by-products are mixed together at the mixing station 20 and an active enzyme is added to the mixture at the enzyme introducing station 30 to soften the skins of the grapes. The mixture, including the active enzyme, is then returned to the mixing station 20 where rice hulls are added to the mixture in a predetermined ratio of grapes to rice hulls. The mixture is then pressed at the first pressing station 40 to extract the bulk of the moisture and the residue is stored at a temperature slightly above freezing for an extended period of time at the cold storage station 50. After the extended period in cold storage is concluded, the residue is pressed again at the second pressing station 60 to extract essentially all of the moisture remaining in the residue. The moisture is collected and further processed for use in other products, and the re-pressed residue is dried at the drying station 70. At the seed separating station 80, the grape seeds are separated from the re-pressed and dried residue and the grape seeds are further processed for use in other products. Finally, the re-pressed, dried and separated residue is ground at the grinding/fragmenting station into a fine, dry powder product having a high concentration of polyphenolic compounds, including resveratrol. Thus, it should be understood and appreciated that the invention should not be construed as being limited to any of the exemplary preferred embodiments described herein, but instead, should be construed as being limited only by the claims appended hereto.

The mixing station 20 of the apparatus 10 comprises any commercially available mixer 25 now known or hereafter devised that is suitable for mixing or combining organic plant matter. In a preferred embodiment, the mixer 25 combines Muscadine grapes and rice hulls in the predetermined ratio previously described to produce a mixture of Muscadine grapes and rice hulls that is suitable for processing according to the method of the invention. The enzyme introducing station 30 comprises any commercially available injector 35 suitable for introducing an active enzyme into organic plant matter, and in particular, into the mixture of Muscadine grapes and rice hulls. The first pressing station 40 comprises any commercially available cold press 45 suitable for pressing, and in particular de-juicing, the mixture of Muscadine grapes and rice hulls. In a preferred embodiment, the cold press 45 is a conventional bladder press or screw press for de-juicing Muscadine grapes at a temperature that does not exceed about 60° F. (15° C.) to extract the bulk of the grape juice from the mixture of Muscadine grapes and rice hulls. The cold storage station 50 comprises any commercially available storage container 55 suitable for storing organic plant matter, and in particular a residue of Muscadine grape pomace or marc, and rice hulls, with or without active enzyme, at a temperature only slightly above 32° F. (0° C.). The second pressing station 60 comprises any commercially available cold press 65, such as a bladder press, screw press or hydraulic press suitable for extracting essentially all of the moisture out of the residue of Muscadine grape pomace or marc, active enzyme and rice hulls, or for extracting grape seed oil and sludge from Muscadine grape seeds separated from the residue. The drying station 70 comprises any commercially available dryer 75 suitable for drying organic plant matter, and in particular, for drying the residue of Muscadine grape pomace or marc, active enzyme and rice hulls using low heat accompanied by air convection at a temperature not exceeding about 120° F. (50° C.). The seed separating station 80 comprises any commercially available seed separator 85 suitable for separating seeds from the residue, and preferably, is a conventional macerator for separating Muscadine grape seeds from the residue of Muscadine grape pomace or marc, active enzyme and rice hulls without the addition of water or a solvent. The grinding/fragmenting station 90 comprises any commercially available grinder or fragmentator 95 suitable for grinding organic plant matter, and in particular, for grinding or fragmenting an essentially dry mixture of Muscadine grape pomace or marc, active enzyme and rice hulls into a dry powder.

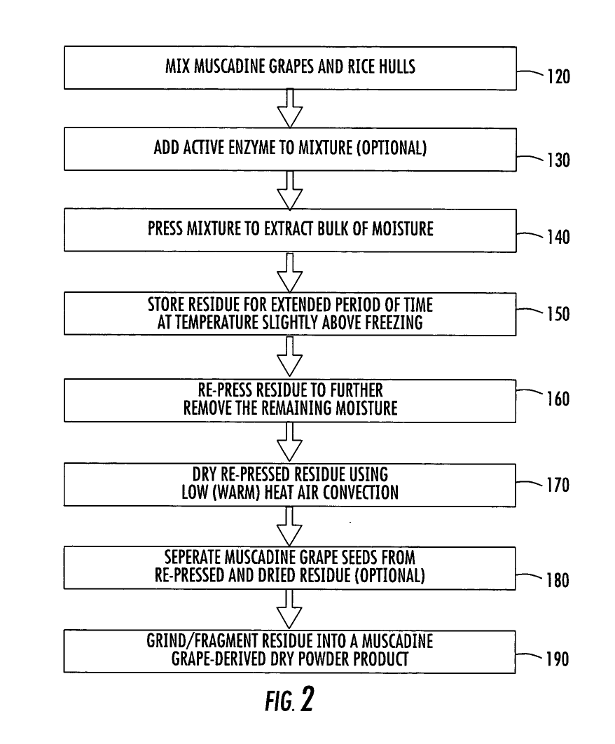

FIG. 2 is a flowchart illustrating the steps of an exemplary method 110 utilizing the apparatus of FIG. 1 to process Muscadine grapes and rice hulls into a dry powder product according to the present invention. The method 110 comprises a first step 120 of mixing Muscadine grapes and rice hulls in a predetermined proportion. In an optional second step 130, an active enzyme is added to the mixture of Muscadine grapes and rice hulls. The active enzyme is introduced into the mixture of Muscadine grapes and rice hull to soften the grape skins and husks, and thereby facilitate the break down of the mixture and the later maceration and powdering process, as well as to promote the metabolic synthesis of polyphenolic compounds, including resveratrol. In a third step 140, the mixture is pressed to extract the bulk of the grape juice present in the Muscadine grapes. The juice is collected and further processed for use in a Muscadine grape-derived juice product having a high concentration of polyphenolic compounds, including resveratrol. Pressing the mixture also results in a residue of Muscadine grape pomace or marc, active enzyme and rice hulls that includes Muscadine grape seeds. The method 110 comprises a fourth step 150 of storing the residue for an extended period of time at a temperature only slightly above 32° F. (0° C.) in order to stimulate and promote the continued metabolic synthesis of polyphenolic compounds, including resveratrol, in the residue. The method 110 comprises a fifth step 160 of re-pressing the residue to remove essentially all of the moisture remaining in the residue following the cold storage period. Alternatively, the grape seeds may be separated as previously described, then pressed to extract grape seed oil and sludge and further processed for use in other nutritional, health and/or therapeutic products having a relatively high concentration of polyphenolic compounds, including resveratrol. The method 110 comprises a sixth step 170 of drying the re-pressed residue (including the Muscadine grape seeds) using a heat source accompanied by warm air convection at a temperature not exceeding about 120° F. (50° C.). The method 110 comprises an optional seventh step 180 of separating the Muscadine grape seeds from the residue. If separated, the grape seeds are further processed as previously described. The method 110 as described herein comprises a final eighth step 190 wherein the pressed, cold-stored, re-pressed and dried residue is ground or fragmented into a Muscadine grape-derived, dry powder product for use alone or in combination with other constituents as a food additive, nutriment, dietary supplement, nutraceutical, pharmaceutical or cosmetic product, such as an over-the-counter health or beauty aid, having a high concentration of polyphenolic compounds, including resveratrol. The foregoing processing steps (except the drying step 170) are preferably performed at a temperature not exceeding about 60F (15C) in order to preserve the relatively high concentration of polyphenolic compounds, including resveratrol, present, promoted or preserved in the residue.

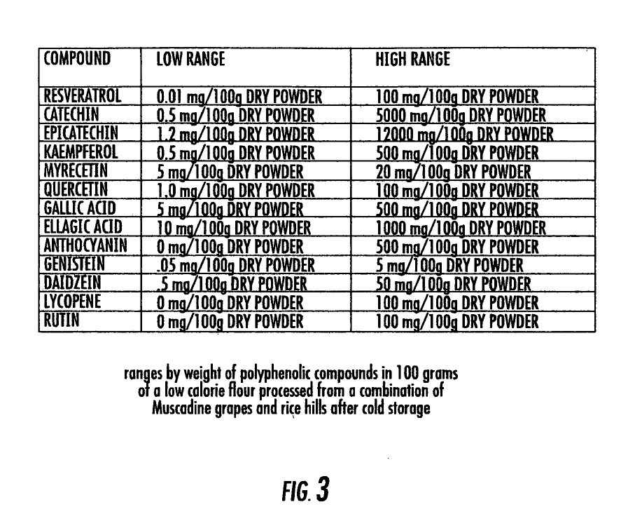

A low calorie combination flour derived principally from Muscadine grapes hulls and rice hulls was produced according to the invention in the manner shown and described herein for use in preparing foodstuffs, such as breads, cookies and cakes. FIG. 3 is a table listing the available ranges by weight of various polyphenolic compounds per 100 grams (100 g) of the low calorie combination flour processed from the mixture of Muscadine grapes and rice hulls according to the method of FIG. 2 using the apparatus of FIG. 1. Dry powder, oil and juice products processed according to the methods described herein and proportionally containing one or more of the polyphenolic compounds listed in the table of FIG. 3 have been observed to provide verifiable nutritional, health and/or therapeutic benefits. In particular, such dry powder products have been documented to be effective in several instances for treating, relieving, alleviating or preventing gout, leukoplakia of the gums, burns of the skin, prostate cancer, topical wounds, cervical cancer, Alzheimer's disease, lupus erythematosis, cataracts, bruising due to coumadin, rhabdomyosarcoma, manic depression, hyperactivity, attention deficit disorder (ADD), post menopausal symptoms (PMS), periodic menstrual cramping, rheumatoid arthritis, inflammatory arthritis, osteoarthritis, colon cancer, elevated cholesterol, correction of abnormal blood lipid profile, hair loss in females, thinning hair, brittle or weak, in-growing or pitting nails, chronic cough, snoring, hyper pigmentation spots on skin, squamous cell skin cancer, poison oak, fibromyalgia, genital herpes, oral herpes, cold sores, Parkinson's disease, throat cancer, sore total joint replacements, thyroiditis, Crohn's disease, high blood pressure, scarring of the heart following a myocardial infarction, elevated prostrate specific antigen (PSA), chronic irritation of fingertips, toetips, fingernails and toenails, tennis elbow, plantar fasciitis, psoriasis, shingles (herpes zoster), carcinoid tumors, breast cancer, throat cancer and seasonal allergies. Such products have also been observed to be effective as a supplement to patients with cancer undergoing chemotherapy or radiation therapy. Products having a high concentration of polyphenolic compounds have also proven to be advantageous for veterinary applications including as a supplement to animal feed for promoting healthy and rapid growth, as well as a preventative for chicken viral infections, chicken bacterial infections, livestock infections, primate infections, equine infections, cat sarcomas, dog infections, tumors, dog arthritis, dog asthma, and horse malignant melanoma. Accordingly, such dry powder, oil and juice products may adequately substitute for antibiotic and growth hormones in animal feed.

Various exemplary embodiments of the present invention have been shown and described herein. However, the invention should not be construed as being limited to the particular embodiments shown and described herein. Instead, the invention should be construed broadly to encompass any and all embodiments that are reasonably foreseeable and that fall within the scope of the appended claims.

That which is claimed is:

1. A method for processing organic plant matter into a food additive, nutriment, dietary supplement, nutraceutical, pharmaceutical or a component of a cosmetic product having a high concentration of a polyphenolic compound, the method comprising:
pressing the organic plant matter to remove at least about 50% of the moisture content from the organic plant matter;
storing the pressed organic plant matter at a temperature greater than about 32° F. (0° C.) and less than about 60° F. (15° C.);
drying the stored organic plant matter; and
grinding the dried organic plant matter.

2. The method according to claim 1 further comprising adding at least one active enzyme to the organic plant matter.

3. The method according to claim 2 wherein the at least one active enzyme is selected from the group consisting of pectinase and amylase types.

4. The method according to claim 1 wherein the organic plant matter comprises seeds and the method further comprises separating the seeds from the dried organic plant matter before grinding.

5. The method according to claim 1 further comprising re-pressing the stored organic plant matter to remove greater than about 80% of the moisture content from the stored organic plant matter.

6. The method according to claim 1 wherein the organic plant matter is stored for at least about 14 days.

7. The method according to claim 1 wherein the organic plant matter is stored for at least about 90 days.

8. The method according to claim 1 wherein the organic plant matter is dried using high air flow convection without the addition of heat in excess of about 120° F. (50° C.).

9. A method according to claim 1 wherein the steps of pressing and grinding are each performed at a temperature less than about 77° F. (25° C.).

10. A method for processing grapes and grape by-products comprising:
mixing rice hulls with the grapes and grape by-products;
pressing the mixture;
storing the pressed mixture at a temperature greater than about 32° F. (0° C.) and less than about 60° F. (15° C.);
drying the stored mixture; and
grinding the dried mixture.

11. A method according to claim 10 further comprising adding at least one active enzyme to the mixture selected from the group consisting of pectinase and amylase types.

12. The method according to claim 10 wherein the mixture comprises grape seeds and the method further comprises separating the grape seeds from the dried mixture before grinding.

13. The method according to claim 10 further comprising re-pressing the stored mixture to remove greater than about 80% of the moisture content from the stored mixture.

14. The method according to claim 10 wherein the mixture is stored for at least about 14 days.

15. The method according to claim 10 wherein the mixture is dried using high air flow convection without the addition of heat in excess of about 120° F. (50° C.).

16. A dry powder for use as a food additive, nutriment, dietary supplement, nutraceutical, pharmaceutical or cosmetic product, the dry powder comprising:
grapes; and
rice hulls;
wherein the grapes and rice hulls are mixed together, then pressed and dried to remove moisture from the mixture, and then ground into the dry powder.

17. A dry powder according to claim 16 wherein the ratio of grapes to rice hulls by weight is at least about 10:1.

18. A dry powder according to claim 16 wherein the ratio of grapes to rice hulls by weight is between about 10:1 and about 50:1.

19. A dry powder according to claim 16 wherein the ratio of grapes to rice hulls by weight is between about 20:1 and about 30:1.

20. A dry powder according to claim 16 further comprising at least one active enzyme selected from the group consisting of pectinase and amylase types.

21. A dry powder according to claim 16 wherein at least the grapes are stored for at least about 14 days at a temperature greater than about 32° F. (0° C.) and less than about 60° F. (15° C.) before the mixture of grapes and rice hulls is dried and ground.

22. A dry powder according to claim 21 wherein the dry powder comprises a concentration of a polyphenolic compound that is greater than at least three times the concentration of the polyphenolic compound when the grapes are not stored for at least 14 days at a temperature greater than about 32° F. (0° C.) and less than about 60° F. (15° C.) before the mixture of grapes and rice hulls is dried and ground.

23. A method of processing a Muscadine grape-derived dry powder, oil or juice product having a high concentration of a polyphenolic compound, the method comprising:
mixing Muscadine grapes and rice hulls in a predetermined proportion;
pressing the mixture to extract the bulk of the grape juice present in the Muscadine grapes, thereby forming a residue comprising at least Muscadine grape marc and rice hulls;
storing the residue for at least about 14 days at a temperature greater than about 32° F. (0° C.) and less than about 60° F. (15° C.) in order to stimulate and promote the continued metabolic synthesis of the polyphenolic compound in the residue;
drying the residue using a heat source accompanied by warm air convection at a temperature not exceeding about 120° F. (50° C.);
grinding the residue into the Muscadine grape-derived dry powder, oil or juice product.

24. The method according to claim 23 further comprising adding at least one active enzyme to the mixture of Muscadine grapes and rice hulls.

25. The method according to claim 24 further comprising re-pressing the residue after storing the residue to remove greater than about 80% of the moisture remaining in the residue.

26. The method according to claim 24 further comprising separating any grape seeds from the mixture and then pressing the grape seeds to extract grape seed oil and sludge.

27. The method according to claim 24 wherein the concentration of the polyphenolic compound by weight ranges between about 0.01 mg and about 100 mg per 100 g of the dry powder product.

28. A Muscadine grape-derived dry powder, oil or juice product having a high concentration of resveratrol, comprising:
a mixture of at least Muscadine grapes and rice hulls wherein the ratio of Muscadine grapes to rice hulls is at least about 10:1;
wherein the concentration of resveratrol by weight ranges between about 0.01 mg and about 100 mg per 100 g of the dry powder product.

29. A Muscadine grape-derived dry powder, oil or juice product according to claim 28 further comprising at least one active enzyme is selected from the group consisting of pectinase and amylase types.

30. A Muscadine grape-derived dry powder, oil or juice product according to claim 28 wherein the mixture of at least Muscadine grapes and rice hulls is stored for at least about 14 days at a temperature of greater than about 32° F. (0° C.) and less than about 60° F. (15° C.) in order to stimulate and promote the continued metabolic synthesis of the resveratrol in the mixture.
